(19) United States
(12) Patent Application Publication
(10) Pub. No.: US 2019/0181901 A1
(43) Pub. Date: Jun. 13, 2019

(54) LOCAL PROFILE ASSISTANT AND APPLICATION PROGRAMMING INTERFACE

(71) Applicant: T-Mobile USA, Inc., Bellevue, WA (US)

(72) Inventor: Babak Namiranian, Bothell, WA (US)

(21) Appl. No.: 15/836,811

(22) Filed: Dec. 8, 2017

(51) Int. Cl. H04B 1/3816; H04L 9/00; H04L 9/30; H04L 9/32; H04L 29/06; H04W 8/18; H04W 8/04

(52) U.S. Cl. CPC H04B 1/3816; H04L 9/006; H04L 9/30; H04L 2463/082; H04L 63/20; H04W 8/183; H04W 8/04; H04L 9/3226

(57) ABSTRACT

This disclosure describes a local profile assistant (LPA) client hosted application that connects to an LPA interface module hosted in the core network and that exposes SIM profile management functionality. When end users are able to obtain validation of a secure connection, the end users can request for modification of their eSIM settings and profiles locally using the LPA client and via the LPA interface module to receive the modification over the air. Additionally, local eSIM management can be enabled by providing an open application programming interface (API) on the server in the core network, wherein the API would operate in concert with the LPA client.

### BACKGROUND

Remote management of embedded UICC (eUICC) or embedded SIM (eSIM) being distinguished from detachable UICC or SIM allows a mobile network operator (MNO) to respond to requests to change subscription from one MNO to another MNO without having physical access to the eUICC in a user equipment or terminal. Generally, eUICCs handle multiple profiles from multiple MNOs, wherein only one profile can be enabled at any time in operation. In this regard, mechanisms for over-the-air remote provisioning and management of eUICCs entail downloading new profiles, updating subscription addresses, and enabling, disabling, or deleting profiles as defined in the GMSA Remote Provisioning Architecture for eUICC Technical Specification. However, remote provisioning and management of eUICC pose several problems.

For instance, end users or consumers are unable to modify their eSIM settings and profiles from their phones or mobile devices locally when switching devices or network providers or mobile carriers. In this regard, many MNOs typically prefer to pre-install their profile for use as a default SM-DP+ (i.e., a single entry stored in the eUICC) at the time of manufacturing that is outside the scope of a downloadable profile. Generally, providing default SM-DP+ provides a better out-of-the box experience for end users because the users are able to download their profile onto their phone and connect to a mobile network.

Alternatively, end users can download their eUICC profile via GMSA root discovery server or an alternate discovery server (SM-DS). Discovery servers allow MNOs to register where devices can query and retrieve the corresponding SM-DP+ address associated with the profile from MNOs. Discovery servers, however, can be disadvantageous in that they incur operational expenses for MNOs and other users. Although GSMA is the sole entity that is to manage the root SM-DS that is to be provided by a single or multiple vendors, it has not yet provided the business model and the cost structure to its consumers (i.e., MNOs).

While default SM-DP+ does not introduce an additional direct cost to MNOs, default SM-DP+ is currently an optional single entry stored in the eUICC. In order to diversify, the MNOs may decide to multisource (profiles and eUICC identifiers) from more than one eUICC manufacturer (EUM) and may connect with multiple subscription managers and vice versa, wherein some MNOs may not directly connect with subscription managers (i.e., profile/eUICC identifier (EID)) ordering might not directly or indirectly include MNOs in the path). Thus, when MNOs wish to diversify their subscription managers, it would have more than one SM-DP+ from different vendors. With the single optional entry model, the implementation of diversifying subscription managers can be very complex. More specifically, it would be complex to determine how to select which SM-DP+ to choose for each subscriber, end user, and/or device, and how each end user device reaches the correct SM-DP+. Thus, the MNO has to decide how they allocate these addresses in multiple devices. The selection becomes very complex, as there are no clear criteria to be chosen ahead of any contracts (e.g., per type of device, per geographic location, etc.).

In various scenarios, therefore, with the addition or replacement of MNOs, servers, user equipment, and eUICC profiles, a fully meshed connectivity are not practical and very difficult to manage.

### BRIEF DESCRIPTION OF THE DRAWINGS

The detailed description is described with reference to the accompanying figures, in which the leftmost digit(s) of a reference number identifies the figure in which the reference number first appears. The use of the same reference numbers in different figures indicates similar or identical items.

FIG. 1 illustrates example network architecture for implementing the local profile assistant.

FIG. 2 is a block diagram showing various components of an illustrative computing device that implements the local profile assistant.

FIG. 3 is a flow diagram of an example process for downloading a profile after a new SM-DP+ is added.

FIG. 4 is a flow diagram of an example process for downloading a profile using a default SM-DP+.

FIG. 5 is a flow diagram of an example process for downloading a profile using an activation code.

### DETAILED DESCRIPTION

This disclosure is directed to a local profile assistant (LPA) that is a client hosted application and an application programming interface (API) for enabling local management of eSIM and eUICC profiles by interacting with an MNO and an API server in a network environment. The MNOs maintain, without limitation, SM-DP or SM-DP+, eUICC profiles, activation codes, and/or other attributes. Upon introduction of a newly added SM-DP+ or a replacement SM-DP+, the MNO is configured to update the server to store an SM-DP+ address that correlates to a new or replaced SM-DP+. Therefore, the server maintains the most up-to-date list of all of the MNO's SM-DP+ addresses in a highly secured environment. It is noted that the same security measures enforced by the GSMA can be implemented to maintain, convey, and store additional SM-DP+ addresses on the server or in a data store. This includes node-to-node as well as end-to-end security (including over the air (OTA)).

Node-to-node security guarantees that data is secure while being transferred from one node to another within a communication system. Data security can encompass multiple aspects. Two common aspects of data security are integrity and privacy considerations. Integrity security employs a technology, such as digital signatures, to prevent data from being tampered with or forged by an unauthorized party. By using a digital signature, a receiver or destination node may be able to verify the sender's identity and know if the data has been altered or forged. Privacy security employs a technology, such as encryption, to restrict access to sensitive data and, thereby, prevent disclosure to or collection by an unauthorized party. One, both, or neither of these security technologies may be employed for the transmission of data. The end-to-end security includes secure data in transit from the platform to external clouds, secure access for users, secure encryption keys, secure logs for auditing, secure instances from breaches, secure data in storage, and the like.

The server updates user equipment with the new or replaced SM-DP+ address. The means by which this information is queried by the device and relayed to the device is part of implementation details (e.g., means similar to OTA, or part of device upgrade, or other means). The protocol used as well as its storage on the user equipment must remain highly secured (e.g., similar to trusted execution environment).

In terms of ownership and maintenance of the server, the server can be owned and maintained by the MNO, jointly owned/maintained by the MNO and original equipment manufacturer (OEM), solely owned and maintained by the OEM, or by any other arrangements that are agreeable to the involved parties. For example, the operational size and geographical span of an MNO can determine its server allocation to provide an optimal coverage for the user equipment.

In various embodiments, default SM-DP+ can take on multiple values within the eUICC of the user equipment. Alternatively, the user equipment can locally store additional SM-DP+ addresses or a default list of SM-DP+ addresses. Adding and/or maintaining additional entries in the eUICC to hold additional SM-DP+ addresses is advantageous in that an eUICC is a tangible element where its requirement and behavior shall comply with the GSMA specifications. In contrast, proposal, discussions, agreements by MNOs, OEMs, and/or EUMs can be extremely time-consuming. In various embodiments, the user equipment can use a default SM-DP+ address as appears in the eUICC in order to request a new profile. If using the default SM-DP+ address results in a successful download of a profile, then the procedure for downloading a profile is completed. Otherwise, the additional optional default SM-DP+ addresses stored in the user equipment can be used to download a profile. More specifically, if using the first default SM-DP+ does not result in a successful download of a profile, the next default SM-DP+ on a queue is used to download a profile, and so on until there is a successful profile download.

In various embodiments, the LPA is configured to manage additions, deletions, or replacements of SM-DP+ as well as MNOs, servers, user equipment, and eUICC profiles using business logics that are implemented by a rules engine. For example, the LPA, via the business logic can automatically route different user equipment to specific profiles using predefined parameters. In this way, the LPA simplifies the complexities of managing multiple profiles by reducing or eliminating changes needed on the part of the MNOs.

Additionally, in order to report a profile status update event to the MNO, either an extension to an existing ES2+ API can be implemented, or a new API can be used to relay the update event to the MNO. API for monitoring and managing profile status updates can take either single value (e.g., single ICCID) and/or take on multiple values or range of values to accommodate bulk profile status updates. Additional considerations may include avoiding a possibility of cloning so that if a profile deletion notification has not been received by an SM-DP+ from a user equipment, SM-DP+ does not allow profile state transposing.

The techniques described herein may be implemented in a number of ways. Example implementations are provided below with reference to the following figures.

### Example Network Architecture

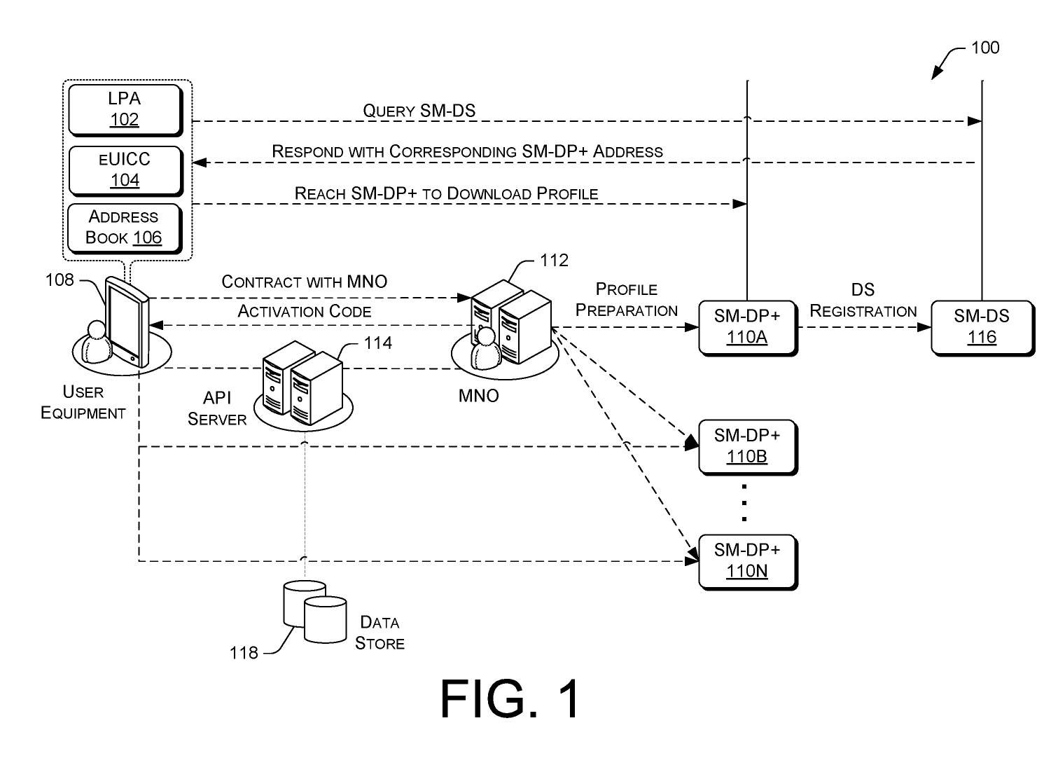

FIG. 1 illustrates an example architecture 100 for implementing a local profile assistant to manage and edit profiles locally from a user equipment. The architecture 100 includes user equipment 108 comprising a local profile assistant application 102 residing thereon, eUICC 104, and an SM-DP+ address book 106, wherein the user equipment 108 is in communication with a server 114 that can comprise an API server and an MNO 112. The MNO 112 is also in communication with the server 114 and a plurality of SM-DP+ 110A-110N.

It is noted that there are no limitations on deployment options. For example, one MNO can be connected to a single server that is connected to multiple user equipment. In another example, one MNO can be connected to a plurality of servers, wherein each server is connected to a user equipment by device type. Additionally, the architecture 100 can include an SM-DS 116 that can receive a query for an SM-DP+ address.

The API server 114 can include general-purpose computers, such as desktop computers, tablet computers, laptop computers, servers (e.g., on-premise servers), or other electronic devices that are capable of receive inputs, process the inputs, and generate output data. In various the embodiments, the server 114 may be operated by a wireless communication carrier, MNO, a third-party entity that is working with the wireless communication carrier such as an OEM, or any combination thereof. The server 114 may store data in a distributed storage system, in which data may be stored for long periods of time and replicated to guarantee reliability. Accordingly, the server 114 may provide data and processing redundancy, in which data processing and data storage may be scaled in response to demand.

Further, in a networked deployment, new servers 114 may be added on the fly without affecting the operational integrity of the LPA 102 described herein. In this regard, the servers 114 can include a plurality of physical machines that may be grouped together and presented as a single computing system. Each physical machine of the plurality of physical machines may comprise a node in a cluster. For example, the cluster comprises a failover cluster that provides failover operation during a cluster-wide outage. However, in other embodiments, the servers 114 may be in the form of virtual machines, such as virtual engines (VE) and virtual private servers (VPS).

In some embodiments, the server 114 is operatively connected to a data store 118. The data store 118 can comprise a home subscriber server (HSS) of a telecommunications network or a home location register (HLR) of the telecommunications network. The data store 118 may store profiles, SM-DP+ addresses, and/or mapping data that is generated from routing a user equipment 108 to an SM-DP+ 110A-110N and vice versa. The data store 118 can also store other information relating to MNOs 112, user equipment 108, and/or so forth. Moreover, the data store 118 can store a tree having a root node for security and that is configured to implement a protocol to coordinate with a third-party entity.

The MNO 112 is connected to a plurality of SM-DP+ 110A-110N, wherein each SM-DP+ is configured to securely package profiles to be provisioned on the eUICC 104 of the user equipment 108. The SM-DP+ 110A-110N manages the installation of these profiles on the eUICC. Consumer profiles can be loaded from EUMs to the corresponding SM-DP+ 110A-110N. Note that for machine to machine (M2M) scenarios, M2M user equipment do not have LPAs. SM-DP+ can provide feed to the MNO to inform the MNO about the loaded profiles upon completion of loading based on agreements between the MNO and the SM-DP+. After receiving feeds, the MNO can update the server properly. The profile enabling procedure between the MNO 112 and the SM-DP+ 110A-110N is used to enable a profile previously downloaded or installed (e.g., default eUICC) on the eUICC 104. The MNO 112 owning the profile to be enabled initiates the profile downloading procedure.

In some embodiments, the profiles can comprise a provisioning profile, an operational profile, and/or a user profile. The provisioning profile includes information for needed to establish a connection to an MNO. The operational profile includes MNO network access information for receiving service therefrom. If there is no provisioning profile, the operational profile can act as the provisioning file, depending upon embodiments. The user profile includes user information, including a short message service (SMS), multimedia messaging service (MMS), user account information, user equipment information, and a phone book. The user profile may be included in an operational profile, depending upon embodiments.

Additionally, each profile can include information related to a corresponding subscription manager and information for establishing a connection or for allowing communication with the subscription manager, and an authentication credential and key information for performing an authentication (e.g., key exchanges). In some embodiments, the authentication credential comprises an Authentication and Key Agreement (AKA) scheme, public key infrastructure (PKI), and/or other authentication protocol such as multifactor authentication and SAS certification.

The profiles enable the subscription managers to communicate with respective user equipment 108 or terminals that comprise eUICCs having matching or corresponding profiles, wherein the eUICCs can be identified by their EID and ICCID. In this regard, a user equipment 108 can access a subscription manager by using a profile selected from one of the profiles stored in the MNO 112 and/or the API server 114. In this way, the user equipment 108 can communicate with an MNO using the subscription manager. The eUICC can automatically perform a user authentication with respect to a mobile communication network, to which a user has subscribed, by using the information stored in the eUICC, so that the user may conveniently receive mobile communication services through the user equipment 108.

The user equipment 108 may include smart phones, game consoles, personal digital assistants (PDAs) or other electronic devices having a wireless communication function that are capable of receive inputs, process the inputs, and generate output data. However, in other embodiments, the user equipment 108 comprises general-purpose computers, such as desktop computers, tablet computers, laptop computers, servers, and so forth. In various embodiments, the user equipment or terminal may include an a consumer terminal. In various the embodiments, the user equipment 108 may be operated by a wireless communication carrier or a third-party entity that is working with the wireless communication carrier.

In various embodiments, the LPA 102 can work in conjunction with an onboarding entity that can provide client privilege responsibility. For example, the onboarding entity can verify if profiles have been loaded and available in the SM-DP+ 110A-110N before a user equipment makes a request for ordering profiles. More specifically, SM-DP+ 110A-110N can provide a feed to the onboarding entity upon loading profiles.

An SM-DP+ 110A-110N receives and processes requests for profiles from a user equipment 108, wherein the user equipment 108 can reach the appropriate SM-DP+ using an SM-DP+ address stored thereon corresponding to the SM-DP+. The SM-DP+ 110A-110N retrieves a profile, and responsive to the request serves at least one of the retrieved eUICCs. The request includes credentials in accordance with PKI-based authentication protocol and/or utilizes multi-factor authentication. The request can also include one or more SAS certificates. In various embodiments, the request utilizes an identifier correlating with an account that is associated with a plurality of user equipment and a plurality of users (e.g., a user identification associated with a wireless service provider, a wireless carrier, a cellular company, a mobile network carrier, etc.).

Profile orders with an SM-DP+ address or other associated information are provided from the user equipment 108 to the MNO 112. In various embodiments, an MNO 112 can use an extension in ES2+ commands to relay the associated metadata attributes related to the order and the SM-DP+ 110A-110N can use the content of the extension to prepare a profile with the requested metadata from the MNO 112. The mapping of this attribute (i.e., part of the extension to ES2+) to metadata attributes (DP+) can be based on an agreement between the MNO 112 and SM-DP+ 110A-110N.

It should be noted that the storage and/or maintenance of SM-DP+ addresses requires secure location on the user equipment 108. The SM-DP+ addresses can be stored as part of LPA 102, device secure execution environment, and/or so forth. The method by which the SM-DP+ addresses get updated is implementation details. For example, the updates could be tied into device operating system upgrade, via OTA, and/or via any other security mechanism.

In various embodiments, SM-DP+ receives a notification indicating a profile was deleted from a user equipment and upon receiving profile delete notification from the user equipment; the profile state may be moved to a newly defined state or state transition. For example, the profile state can be moved as temporarily deleted. Additional considerations may include avoiding a possibility of cloning. If delete notification has not been received by SM-DP+ from the user equipment; SM-DP+ shall not allow this profile state transposing. SM-DP+ can report to an MNO of the profile delete notification. To relay this information, either an extension to an existing ES2+ API can be implemented, or a new API can be used to relay the event to the MNO. Profile status change API can also be a new API to be defined between the MNO and the SM-DP+. The API can take either single value (such as single ICCID) and/or take on multiple values or range of values to accommodate bulk updates.

There can be instances where notifications may not have been properly received by the MNO. In this regard, the MNO determines whether it received the profile delete notification from the SM-DP+. If the MNO does not receive the notification, the MNO transmits a query on the profile status to the SM-DP+ or requests for the state transition. If the profile status in SM-DP+ does not indicate that the profile state was moved as temporarily deleted, then the MNO may not proceed with status change request as there is a high probability that the profile may not have been deleted or not properly deleted from the user equipment. If the notification has been received by the MNO, the MNO can check the billing status associated with the deleted profile. The MNO determines whether the profile is active in the billing system (e.g., the profile was not deleted by accident). If the profile is active in the billing system, the profile can be reused only by the same EID. If the profile is not active in the billing system, the profile can be reused by any. The SM-DP+ receives requests for profile state transition from the MNO based at least partially on the MNO's business logic.

### Example Computing Device Components

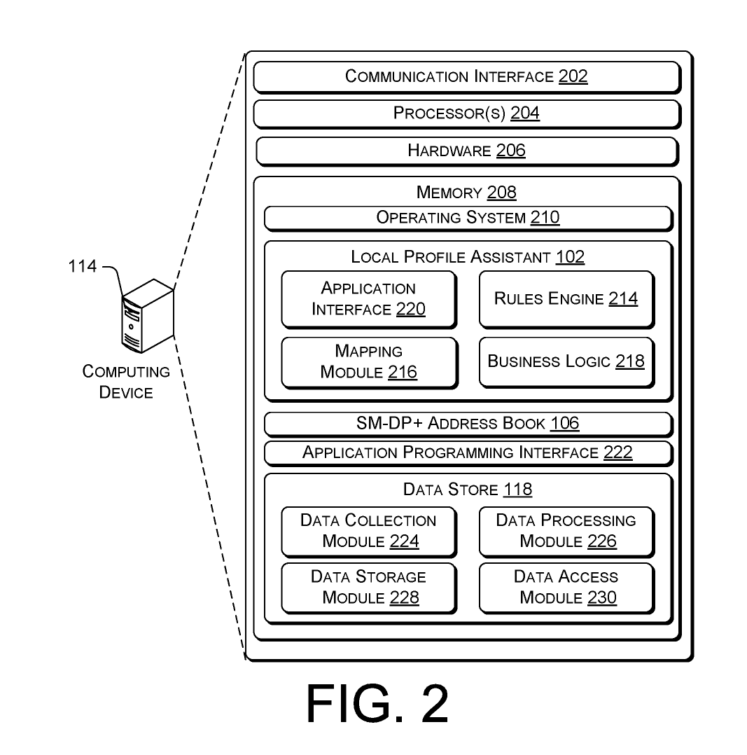

FIG. 2 is a block diagram showing various components of an illustrative computing device 114 that implements the application programming interface for the LPA. In various embodiments, the computing device 114 comprises an API server and may include a communication interface 202, one or more processors 204, hardware 206, and memory 208. The communication interface 202 may include wireless and/or wired communication components that enable the computing device 114 to transmit data to and receive data from other networked devices. The processor 204 can integrate with an enterprise resource planning (ERP) system. The hardware 206 may include additional user interface, data communication, or data storage hardware. For example, the user interfaces may include a data output device (e.g., visual display, audio speakers), and one or more data input devices. The data input devices may include but are not limited to, combinations of one or more of keypads, keyboards, mouse devices, touch screens that accept gestures, microphones, voice or speech recognition devices, and any other suitable devices.

The memory 208 may be implemented using computer-readable media, such as computer storage media. Computer-readable media includes, at least, two types of computer-readable media, namely computer storage media and communications media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms. The memory 208 may also include a firewall. In some embodiments, the firewall may be implemented as a hardware 206 in the computing device 114.

The processors 204 and the memory 208 of the computing device 114 may implement an operating system 210, the local profile assistant 102, SM-DP+ address book 106, application programming interface 222, and data store 118. The operating system 210 may include components that enable the computing device 114 to receive and transmit data via various interfaces (e.g., user controls, communication interface, and/or memory input/output devices), as well as process data using the processors 204 to generate output. The operating system 210 may include a presentation component that presents the output (e.g., display the data on an electronic display, store the data in memory, transmit the data to another electronic device, etc.). Additionally, the operating system 210 may include other components that perform various additional functions generally associated with an operating system.

The local profile assistant 102 includes a rules engine 214, a mapping module 216, a business logic 218, and an application interface 220. The modules may include routines, program instructions, objects, and/or data structures that perform particular tasks or implement particular abstract data types.

The mapping module 216 is configured to enable a user equipment to reach a correct SM-DP+ and vice versa. In one example, the mapping module 216 is configured to access the SM-DP+ addresses book 212 in order to retrieve an SM-DP+ address and retrieve a profile from an SM-DP+ having a corresponding SM-DP+ address. The mapping module 216 can communicate with the rules engine 214 that can implement business logic 218 to route user equipment to a dedicated SM-DP+ via affinity pairing or affinity routing. For example, the operating system can guarantee that a particular core on a CPU will handle a request, or a load balancer can guarantee that a particular web server will handle a particular HTTP request. In various embodiments, the strength of the relationship between the user equipment and the SM-DP+ can be quantified via an affinity coefficient, wherein if the affinity coefficient exceeds a specified threshold, the user equipment can be paired with the SM-DP+. Said another way, the rules engine 214 can implement business logic 218 to guarantee that a request for profile is handled by a particular SM-DP+. Additionally, an SM-DP+ can be decommissioned in a convenient manner as the affinity coefficient decreases below the specified threshold or based on affinity routing arrangements. In various embodiments, the rules engine 214 is configured to pair user equipment with only a specific group or a known subset of SM-DP+ or to a failover cluster of SM-DP+.

In various embodiments, the rules engine 214 is configured to implement business logic 218 to route user equipment to specific SM-DP+ in various scenarios such as additions, deletions, disablements, or replacements of profiles. For example, the business logic 218 is configured to initially internally map the user equipment to a first SM-DP+, and then to automatically to a second SM-DP+ when a profile is deleted. Without limitation, the business logic can be based on network partition, round robin, queue, and/or other predefined parameters. For example, the rules engine 214, based on the business logic 218, can make an initial determination as to the particular sequence in which an SM-DP+ may be selected from a plurality of SM-DP+. The determination may be made based on data inputs received from a network engineer, depending upon embodiments.

In various embodiments, the mapping module 216 can verify whether the correct profile is available. For example, the mapping module 216 can communicate with an onboarding entity that receives feeds from one or more SM-DP+. Additionally, the mapping module 216 can receive authentication parameters for remote provisioning from the SM-DP+ and receive security credentials therefrom upon verification of authentication parameters. In some embodiments, the mapping module 216 is configured to perform key exchanges and/or generate a secure digital identifier based on the security credentials.

The application interface 220 may enable the local profile assistant 102 to communicate with one or more components of the present system and to receive inputs and route outputs to various applications. For example, the application interface 220 may enable a user (e.g., a network engineer, an administrator, an administrative entity, etc.) to manually select a specific SM-DP+ or ranges of SM-DP+. The application interface 220 may also display information relating to one or more servers, MNOs, user equipment, SM-DP+, and/or so forth via a user interface display. For example, the application interface 220 can display mapping information, profile information, identifiers, and/or so forth.

The data store 118 can include a data collection module 224, a data processing module 226, a data storage module 228, and a data access module 230. The data collection module 224 may use data adaptors to retrieve data from the structured or unstructured data sources such as MNOs, user equipment, and/or so forth. In this regard, the data collection module 224 may use data-agnostic data adaptors to access the data sources without taking into consideration the underlying content of the data. Further, changes to the data content in each data source the do not affect the functionality of the corresponding data-agnostic data adaptors. On the other hand, the data collection module 224 may use database-specific data adaptors to access structured databases.

The data collection module 224 may include a workflow scheduler that periodically checks for and retrieves newly available data from the multiple data sources. The workflow scheduler may handle the extraction and the handling of the data based on configurable policies. For example, a configurable policy may specify the source data location, frequency of data retrieval, handling procedures for late arrival data, data retention period, and data disposal following an expiration of the data retention period. The handling procedures for the late arrival data may specify a predetermined cutoff period during which any data arriving late may be incorporated with data that is retrieved on time for processing. Accordingly, the data collection module 224 may retrieve data with different generation latencies (e.g., one minute, fifteen minutes, one hour, one day etc.), as well as data with different spatial aggregation (e.g., network cell data, network node data, radio network controller data, etc.) such that real time or non-real time data analysis may be performed.

In various embodiments, the data processing module 226 may implement adaptor-specific logics to decode the format of various data from data sources. Accordingly, collected data may be fed into other modules for analysis and storage. In some embodiments, the data processing module 226 may aggregate data from multiple data sources for a particular time period into an aggregated data file of data sets according to one or more grouping parameters. The grouping parameters may include specific time periods (e.g., hourly, daily, etc.), network components, user device vendor, user device models, and/or so forth. In other embodiments, the grouping parameters may be used to aggregate the data into multiple datasets that correspond to different levels of a network hierarchy. For example, the data may be aggregated into datasets that correspond to a subscriber level, a device level, a service area level, and a geographical market level. The geographical market level may further include a zip code sublevel, a municipality sublevel, or another location-based sublevel that may correspond to datasets for aggregation. Nevertheless, the aggregated data from the multiple data sources may be stored in the data sets according to their own storage schemas. In other embodiments, the data processing module 226 may converge the data from multiple data sources for a particular time period into a converged data file of data sets, in which the data are stored in the data sets according to a unitary storage schema.

The data storage module 228 may store data across multiple virtual data storage clusters with redundancy, so that the data may be optimized for quick access. The stored data may include the performance data from data sources, the aggregated and covered data files, data that are generated by the local profile assistant 102, and/or so forth. The data access module 230 may provide a data access API for accessing the data stored in the multiple virtual storage clusters. Accordingly, the API may be used by the local profile assistant 102 as well as other third-party application to access the data that received and stored by the data store 118.

### Example Processes

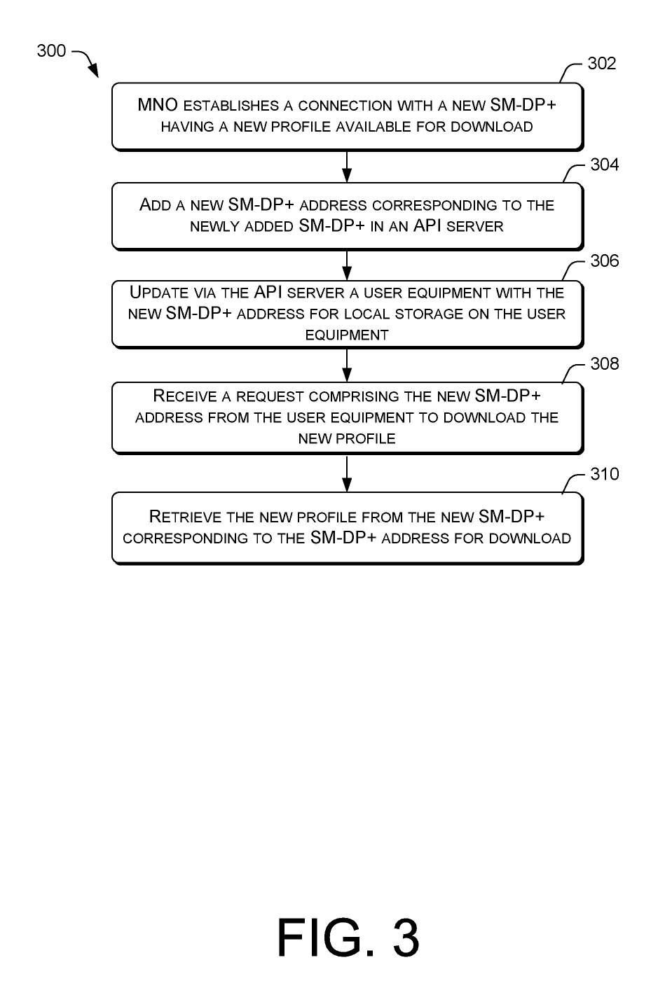

FIGS. 3-5 present illustrative processes 300-500 for mapping different enterprise entities to one or more specific subscription managers and managing profiles. Each of the processes 300-500 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 300-500 are described with reference to the architecture 100 of FIG. 1.

FIG. 3 is a flow diagram of an example process for downloading a profile after a new SM-DP+ is added. At block 302, an MNO adds a new SM-DP+ having at least one profile available for download by a user equipment. At block 304, the MNO adds a new SM-DP+ address corresponding to the newly added SM-DP+ in an API server. The MNO can be connected to any number of servers and each server can be connected to any number of user equipment. In some embodiments, the server can be connected to the user equipment by type or can serve all equipment or device type. At block 306, the API server updates a user equipment connected to the server with the new SM-DP+ address for local storage on the user equipment. At block 308, the MNO receives a request comprising the new SM-DP+ address from the user equipment for downloading a profile. At block 310, the MNO enables the user device to retrieve a new profile from the new SM-DP+ corresponding to the SM-DP+ address. In various embodiments, the mapping module can validate that the user equipment has reached the correct SM-DP+ or the correct selection of SM-DP+. Additionally, the user equipment can receive authentication parameters from the SM-DP+ for remote provisioning and receive security credentials therefrom upon verification of authentication parameters. In various embodiments, the mapping module can utilize affinity routing such that the request is guaranteed to be routed to the unique SM-DP+ and only the unique SM-DP+. If the SM-DP+ is available, the MNO enables the user equipment to retrieve the profile for download. Conversely, if the SM-DP+ is not available, the MNO can return an error indication.

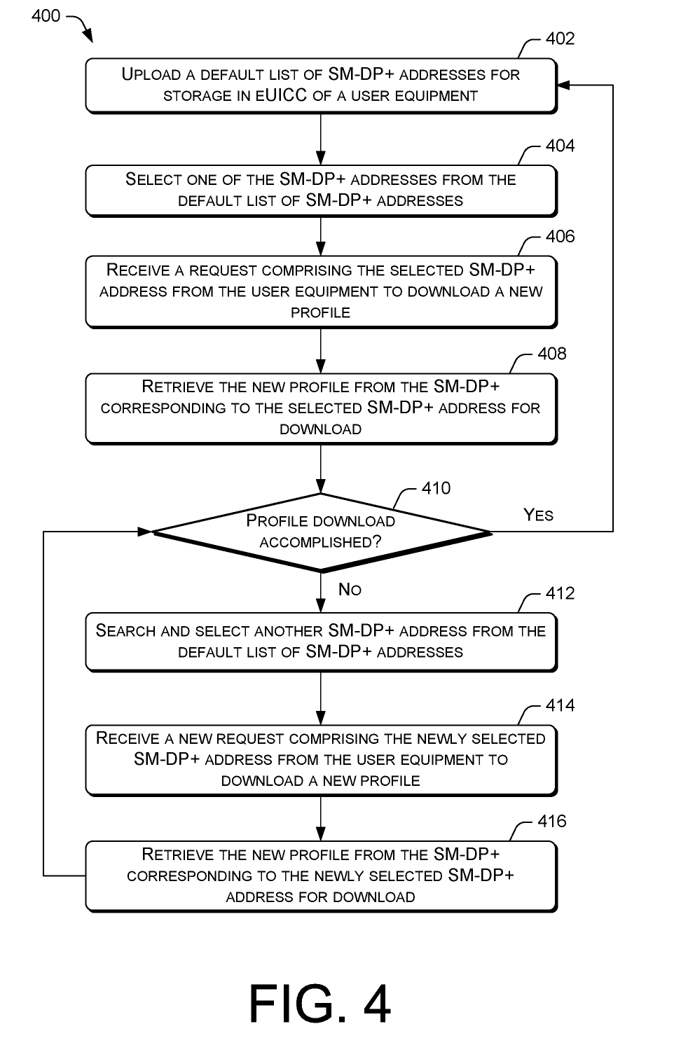

FIG. 4 is a flow diagram of an example process for downloading a profile using a default SM-DP+. At block 402, a default list of SM-DP+ addresses comprising a plurality of SM-DP+ addresses is loaded onto the eUICC or another memory unit of user equipment for local storage. At block 404, the mapping module of the local profile assistant selects one of the SM-DP+ addresses from the default list. The SM-DP+ addresses can be listed in a queue in the user equipment such that the mapping module reads the first SM-DP+ address listed in the user equipment, then the second SM-DP+ address listed in the user equipment, and so forth. Alternatively, the mapping module can be programmed to read the SM-DP+ addresses in a predetermined order (e.g., round robin). At block 406, an MNO receives a request comprising the selected SM-DP+ address from the user equipment for downloading a new profile. At block 408, the MNO retrieves the new profile from the SM-DP+ corresponding to the selected SM-DP+ address.

At decision block 410, the user equipment determines whether the new profile was successfully downloaded. If the new profile was not successfully downloaded (“no” response from decision block 410), the mapping module searches and selects another SM-DP+ address from the default list stored in the user equipment as indicated in block 412. At block 414, the MNO receives a new request comprising the newly selected SM-DP+ address from the user equipment to download the new profile. At block 416, the MNO retrieves the new profile from the SM-DP+ corresponding to the newly selected SM-DP+address. Thereafter, the process returns to the decision block 410 to determine whether the new profile was successfully downloaded. This process is repeated until the new profile is successfully downloaded onto the user equipment. Thus, the local profile assistant determines whether a profile has been downloaded each time the mapping module queries down the list of addresses in order to ensure that a profile has been downloaded. In various embodiments, the API server ensures that the user equipment comprises valid SM-DP+ addresses are stored in the eUICC of the user equipment such that the user equipment can reach proper SM-DP+. More specifically, the server, via the MNO, determines whether one or more SM-DP+ has been disabled or decommissioned. If an SM-DP+ has been disabled or decommissioned, the MNO updates the server to remove the SM-DP+ address associated with the disabled or decommissioned SM-DP+. In this way, the user equipment is prevented from reaching a disabled SM-DP+ to download a profile. Similarly, if an SM-DP+ has been added, the MNO updates the server to add the SM-DP+ address associated with the newly added SM-DP+.

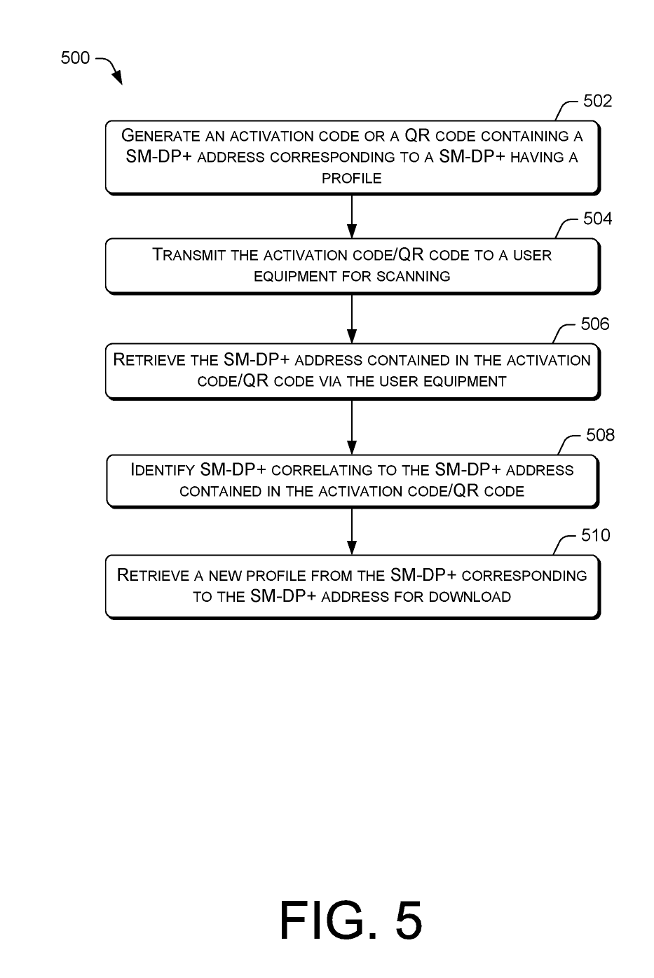

FIG. 5 is a flow diagram of an example process for downloading a profile using an activation code. At block 502, the MNO generates an activation code such as a QR code, wherein the activation code comprises an SM-DP+ address corresponding to an SM-DP+ having a profile. At block 504, the MNO transmits the activation code to a user equipment. At block 506, the user equipment retrieves the SM-DP+ address based on the activation code. At block 508, the user equipment identifies an SM-DP+ correlating to the SM-DP+ address in the activation code. At block 510, the user equipment reaches the SM-DP+ to download the profile.

The techniques herein describe a local profile assistant for employing local eSIM profile management functionality. By storing multiple SM-DP+ addresses within a user equipment, the user equipment can increase the likelihood of successfully retrieving a profile from an SM-DP+ having at least one of the stored SM-DP+ address to provide an end user with a better out-of-the box experience. In this way, the local profile assistant can adapt to various operating scenarios as described in the embodiments in order to reduce the burden on the end users who would otherwise be unable to modify their eSIM settings and profiles locally and to operate in a more simplistic manner than operating via a discovery server or using a single default SM-DP+ address. As the interconnectivities among user equipment, servers, and MNOs become more densified and complex over time, the ability to manage eSIM profile locally may lead to improved remote provisioning and management of the eUICC.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. One or more non-transitory computer-readable media storing computer-executable instructions that upon execution cause one or more processors to perform acts comprising:
receiving, from a user equipment, a request comprising a subscription manager data preparation (SM-DP+) address corresponding to a unique SM-DP+ of a plurality of SM-DP+s, the SM-DP+ address selected from a plurality of SM-DP+ addresses stored in the user equipment;
performing an affinity routing of the request to the unique SM-DP+, such that the request is guaranteed to be routed to the unique SM-DP+ and only the unique SM-DP+;
if the unique SM-DP+ is available:
retrieving a profile from the unique SM-DP+ corresponding to the received SM-DP+ address;
transmitting the profile to the user equipment for download; and
if the unique SM-DP+ is not available, returning an error indication to the user equipment to select a second SM-DP+ address from the plurality of SM-DP+ addresses stored in the user equipment.

2. The one or more non-transitory computer-readable media of claim 1, wherein the request includes credentials in accordance with a public key infrastructure (PKI)-based authentication protocol.

3. The one or more non-transitory computer-readable media of claim 1, wherein the request utilizes a multi-factor authentication.

4. The one or more non-transitory computer-readable media of claim 1, wherein the request utilizes an identifier correlating with an account that is associated with the user equipment.

5. The one or more non-transitory computer-readable media of claim 1, wherein the one or more non-transitory computer-readable media includes a firewall.

6. (canceled)

7. The one or more non-transitory computer-readable media of claim 1, wherein the acts further comprise:
uploading a new SM-DP+ address corresponding to a new SM-DP+ onto the user equipment;
receiving, from the user equipment, a second request comprising the new SM-DP+ address corresponding to the new SM-DP+, the new SM-DP+ address selected from the plurality of SM-DP+ addresses stored in the user equipment based at least partially on predetermined parameters;
if the new SM-DP+ is available:
retrieving a second profile from the new SM-DP+ corresponding to the new SM-DP+ address; and
transmitting the second profile to the user equipment for download.

8. The one or more non-transitory computer-readable media of claim 1, wherein the acts further comprise:
updating a server with the SM-DP+ address corresponding to the unique SM-DP+ for storage to enable the server to upload the user equipment with the SM-DP+ address.

9. One or more non-transitory computer-readable media storing computer-executable instructions that upon execution cause one or more processors to perform acts comprising:
uploading a plurality of subscription manager data preparation (SM-DP+) addresses onto a user equipment, each of the plurality of SM-DP+ addresses corresponding to a unique SM-DP+;
receiving, from the user equipment, a request comprising a first SM-DP+ address of the plurality of SM-DP+ addresses stored in the user equipment;
performing an affinity routing of the request to the unique SM-DP+, such that the request is guaranteed to be routed to the unique SM-DP+ and only the unique SM-DP+;
retrieving a profile from the unique SM-DP+ corresponding to the first SM-DP+ address;
transmitting the profile to the user equipment for download;
determining whether the user equipment successfully downloaded the profile;
if the user equipment does not successfully download the profile, receiving a second request comprising a second SM-DP+ address of the plurality of SM-DP+ addresses stored in the user equipment;
retrieving a second profile from a second SM-DP+ corresponding to the second SM-DP+ address; and
transmitting the second profile to the user equipment for download.

10. The one or more non-transitory computer-readable media of claim 9, wherein the acts further comprise:
uploading a new SM-DP+ address corresponding to a new SM-DP+ onto the user equipment;
receiving a third request comprising the new SM-DP+ address stored in the user equipment;
retrieving a third profile from the new SM DP+; and
transmitting the third profile to the user equipment for download.

11. The one or more non-transitory computer-readable media of claim 9, wherein the one or more non-transitory computer-readable media includes a node in a failover cluster.

12. The one or more non-transitory computer-readable media of claim 9, wherein the request utilizes an affinity coefficient.

13. The one or more non-transitory computer-readable media of claim 9, wherein the one or more non-transitory computer-readable media comprises an on-premise server, wherein the on-premise server is not the unique SM-DP+.

14. The one or more non-transitory computer-readable media of claim 9, wherein the acts further comprise:
determining whether a profile delete notification is received from the SM-DP+; and
transmitting a profile status query to the SM-DP+ in response to determining that the profile delete notification is not received from the SM-DP+.

15. A system, comprising:
one or more nontransitory storage mediums configured to provide stored code segments, the one or more nontransitory storage mediums coupled to one or more processors, each configured to execute the code segments and causing the one or more processors to:
upload a plurality of subscription manager data preparation (SM-DP+) addresses onto a user equipment, each of the plurality of SM-DP+ addresses corresponding to a unique SM-DP+;
receive, from the user equipment, a request comprising one of the plurality of SM-DP+ addresses stored in the user equipment;
perform an affinity routing of the request to the unique SM-DP+, such that the request is guaranteed to be routed to the unique SM-DP+ and only the unique SM-DP+;
retrieve a profile from the unique SM-DP+ corresponding to the received SM-DP+ address;
transmit the profile to the user equipment for download; and
determine whether the user equipment successfully downloaded the profile;
if the user equipment does not successfully download the profile,
receive a second request comprising another one of the plurality of SM-DP+ addresses stored in the user equipment;
retrieve a second profile from a second SM-DP+ corresponding to the newly received SM-DP+ address; and
transmit the second profile to the user equipment for download.

16. (canceled)

17. The system of claim 15, wherein the one or more processor is further configured to:
upload a new SM-DP+ address corresponding to a new SM-DP+ onto the user equipment;
receive a third request comprising the new SM-DP+ address corresponding to the new SM-DP+;
retrieve a third profile from the new SM-DP+ corresponding to the new SM-DP+ address; and
transmit the third profile to the user equipment for download.

18. The system of claim 15, further comprising a data store, wherein the data store is a home subscriber server (HSS) of a telecommunications network or a home location register (HLR) of the telecommunications network.

19. The system of claim 15, wherein the one or more processor is further configured to integrate with an enterprise resource planning (ERP) system.

20. (canceled)

21. The one or more non-transitory computer-readable media of claim 1, wherein the user equipment selects the SM-DP+ address based at least partially on an activation code corresponding to the unique SM-DP+.

22. The one or more non-transitory computer-readable media of claim 1, wherein the one or more non-transitory computer-readable media comprises an on-premise server, wherein the on-premise server is not the unique SM-DP+.

23. The system of claim 16, wherein the newly received SM-DP+ address is automatically selected from the plurality of SM-DP+ addresses based on predefined parameters.
